(19) United States
(12) Patent Application Publication
(10) Pub. No.: US 2024/0408623 A1
(43) Pub. Date: Dec. 12, 2024

(54) WATER OUTLET DEVICE

(71) Applicant: RUNNER(XIAMEN) CORP., XIAMEN (CN)

(72) Inventors: Bifu DAI, XIAMEN (CN); Xinzhan HU, XIAMEN (CN)

(73) Assignee: RUNNER(XIAMEN) CORP., XIAMEN (CN)

(21) Appl. No.: 18/656,759

(22) Filed: May 7, 2024

(30) Foreign Application Priority Data
Jun. 8, 2023 (CN) 202321458434.7

(51) Int. Cl. B05B 1/18

(52) U.S. Cl. CPC B05B 1/185

(57) ABSTRACT

A water outlet device is provided. The water outlet device includes a first body, a second body, and a support arm. The first body includes a first panel for water outlet; the second body includes a second panel for water outlet; and one end of the support arm is able to be cooperatively connected with the first body, and one other end of the support arm is able to be cooperatively connected with the second body; the second body is able to be moved relative to the first body under the cooperation of the support arm to enable the first panel to form a new water outlet mode in combination with the second panel.

### CROSS-REFERENCE TO THE RELATED APPLICATIONS

This application is based upon and claims priority to Chinese Patent Application No. 202321458434.7, filed on Jun. 8, 2023, the entire contents of which are incorporated herein by reference.

### TECHNICAL FIELD

The present invention relates to a water outlet device.

### BACKGROUND

The popular shower combinations in the current market can be divided into the upper and lower distribution of the rosette head and showerhead, and the way in which the rosette head and showerhead are combined together concentric. Both have their own advantages and shortcomings, the distribution method of upper and lower cannot be used in concentric combinations, and the distribution method of concentric combinations cannot be used in the upper and lower distribution, which resulting in the current shower combination products are limited and cannot meet the different choices of different users.

### SUMMARY

In order to solve the above technical problems, it is an object of the present invention to provide a water outlet device.

The present invention is realized by the following technical solutions:

A water outlet device, wherein comprises: a first body, the first body comprising a first panel for water outlet; a second body, the second body comprising a second panel for water outlet; a support arm, one end of the support arm can be rotationally and cooperatively connected with the first body, and one other end of the support arm can be rotationally and cooperatively connected with the second body; the second body being capable of being moved relative to the first body under the rotationally coupled of the support arm, so that the first panel and the second panel can converge or separate.

In an embodiment of the present invention, the first body comprises a first joint capable of being rotationally and cooperatively connected to the wall, and the second body comprises a second joint rotationally and cooperatively connected to the other end of the support arm; a rotationally connecting damping mechanism is provided between one end of the support arm and the first body, and a rotationally connecting damping mechanism is also provided between the other end of the support arm and the second joint.

In an embodiment of the present invention, the rotationally connecting damping mechanism comprises a bolt and a nut, which are matched with each other, the bolt and nut rotationally and cooperatively connecting the support arm to the first body and the second joint, an outer circumference of the bolt is equipped with a friction ring, and one end face of the friction ring is matingly connected to the support arm, and one other end face of the friction ring is cooperatively connected to the first body or the second joint.

In an embodiment of the present invention, the first panel is capable of changing the water outlet angle by rotation in conjunction with the first joint, and the second panel is capable of changing the water outlet angle by rotation in conjunction with the second joint.

In an embodiment of the present invention, one end of the support arm is rotationally connected to the first body, and the other end of the support arm is capable of being flipped forward or backward with respect to the first body; after the support arm has been flipped, the first panel is capable of being added to the second panel to form an outlet panel with an increased water outlet area.

In an embodiment of the present invention, the first panel is provided with a vacant portion, the second panel can be placed within the vacant portion, and the contour of the second panel can be adapted to the contour of the vacant portion.

In an embodiment of the present invention, the first panel is a polygonal panel and the second panel is a polygonal panel, the second panel being able to be located on and close to the side of the first panel after being flipped with the rotational cooperation of the support arm, so that the first panel and the second panel form a new polygonal panel.

In an embodiment of the present invention, one end of the support arm is rotationally connected to the first body, and the other end of the support arm is capable of being flipped sideways with respect to the first body; after the support arm is flipped, the second panel can be disposed on the side of the first panel, or the first panel and the second panel can be added together to form an outlet panel with an increased area for the outlet of water.

In an embodiment of the present invention, the first panel is provided with a vacant portion, the second panel can be placed within the vacant portion, and the contour of the second panel can be adapted to the contour of the vacant portion.

In an embodiment of the present invention, the first panel is a polygonal panel and the second panel is a polygonal panel, the second panel being able to be located on and close to the side of the first panel after being flipped with the rotational cooperation of the support arm, so that the first panel and the second panel form a new polygonal panel.

A water outlet device of the present invention has the following beneficial effects: the first panel and the second panel can be used separately and individually, at the same time, the first panel and the second panel can also be combined to form a large area shower outlet panel, and can also be separated and combined to form a different combination of water outlet, so as to satisfy the showering effect of the user's different needs.

### BRIEF DESCRIPTION OF THE DRAWINGS

In order to more clearly illustrate the technical solution of the present invention, the following will briefly introduce the accompanying drawings that need to be used in the description of the embodiments or prior art, and it will be obvious that the accompanying drawings in the following description are only some embodiments of the present invention, and other accompanying drawings can be obtained according to these drawings for the person of ordinary skill in the field without putting in creative labor.

FIG. 1 is a schematic diagram I of the state of embodiment I of the present invention.

FIG. 2 is a schematic diagram II of the state of embodiment I of the present invention.

FIG. 3 is a schematic diagram III of the state of embodiment I of the present invention.

FIG. 4 is a side view of embodiment I of the present invention.

FIG. 5 is an exploded view of embodiment I of the present invention.

FIG. 6 is a schematic diagram of the damping mechanism in the present invention.

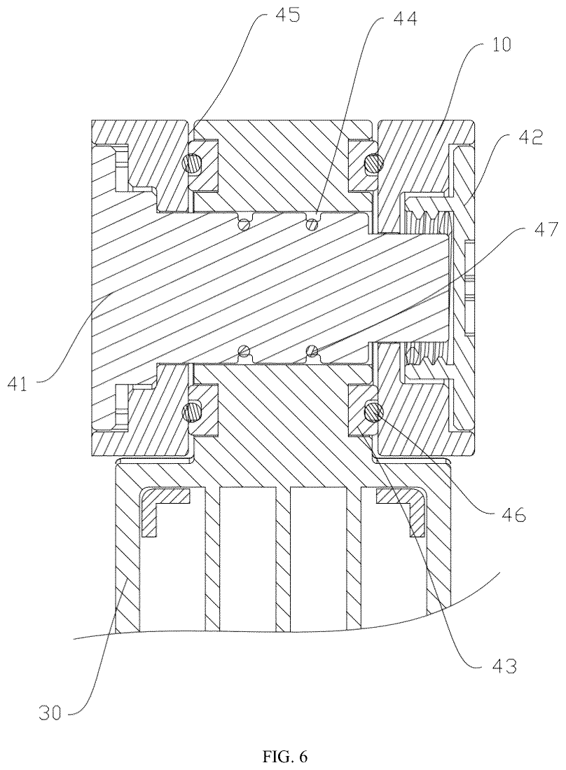

FIG. 7 is a schematic diagram I of the second embodiment of embodiment I of the present invention.

FIG. 8 is a schematic diagram II of the second embodiment of embodiment I of the present invention.

FIG. 9 is a schematic diagram of the first embodiment of embodiment I of the present invention.

FIG. 10 is a schematic diagram of the second embodiment of embodiment I of the present invention.

FIG. 11 is another schematic diagram of embodiment II of the present invention.

### DETAILED DESCRIPTION OF THE EMBODIMENTS

In order to make the objects, technical solutions and advantages of the embodiments of the present invention clearer, the technical solutions in the embodiments of the present invention will be described clearly and completely in the following in conjunction with the accompanying drawings in the embodiments of the present invention, and it is clear that the embodiments described are a part of the embodiments of the present invention and not all of the embodiments. Based on the embodiments in the present invention, all other embodiments obtained by a person of ordinary skill in the art without creative labor fall within the scope of protection of the present invention. Accordingly, the following detailed description of the embodiments of the present invention provided in the accompanying drawings is not intended to limit the scope of the present invention for which protection is claimed, but rather represents only selected embodiments of the present invention. Based on the embodiments in the present invention, all other embodiments obtained by a person of ordinary skill in the art without creative labor fall within the scope of protection of the present invention.

In the description of the present invention, it is to be understood that the terms “center”, “longitudinal”, “lateral”, “length”, “width”, “thickness”, “top”, “bottom”, “front”, “back”, “left”, “right”, “vertical”, “horizontal”, “top”, “bottom”, “inside”, “outside,” “clockwise,” “counterclockwise,” and the like indicate orientation or positional relationships based on those shown in the accompanying drawings, solely for the purpose of facilitating description of the present invention and simplifying the description They are not intended to indicate or imply that the devices or components referred to must have a particular orientation, be constructed and operated in a particular orientation, and therefore are not to be construed as a limitation of the present invention.

Furthermore, the terms “first” and “second” are used for descriptive purposes only and are not to be understood as indicating or implying relative importance or implicitly specifying the number of technical features indicated. Thus, a feature defined with the terms “first”, “second” may expressly or implicitly include one or more such features. In the description of the present invention, “more than one” means two or more, unless otherwise expressly and specifically limited.

In the present invention, unless otherwise expressly provided and limited, the terms “mounted”, “connected”, “connected”, “fixed”, etc. are to be understood in a broad sense. The terms “mounted”, “connected”, “connected”, “fixed”, etc. are to be understood in a broad sense, for example, it can be a fixed connection, a removable connection, or a one-piece connection; it can be a mechanical connection or an electrical connection; it can be a direct connection or an indirect connection through an intermediary medium, and it can be a connectivity within the two elements or an interaction between the two elements. For those of ordinary skill in the art, the specific meanings of the above terms in the present invention may be understood on a case-by-case basis.

In the present invention, unless otherwise expressly provided and limited, “over” or “under” the first feature of the second feature may include direct contact of the first and second features, or may include contact of the first and second features not directly but by means of an additional feature between them. The first feature is in contact with the second feature. Furthermore, the first feature being “above”, “above” and “above” the second feature includes the first feature being directly above and diagonally above the second feature, or simply indicating that the first feature is horizontally higher than the second feature. above the second feature. The first feature being “below”, “under”, and “beneath” the second feature includes the first feature being directly below and diagonally below the second feature, or simply indicating that the first feature is horizontally smaller than the second feature.

With reference to the accompanying drawings of the specification, a water outlet device comprising: a first body 10, the first body comprising a first panel 11 for water outlet; a second body 20, the second body comprising a second panel 21 for water outlet; a support arm 30, one end of the support arm can be rotationally and cooperatively connected with the first body, and the other end of the support arm can be rotationally and cooperatively connected with the second body; the second body being capable of being moved relative to the first body under the rotationally coupled of the support arm, so that the first panel and the second panel can come together or separate, realizing a combination of a new water dispensing pattern. In the use of the present invention, the first body can be a top spray outlet body, the second body can be a hand-held shower, the second body can be separated from the support arm for separate use, and the two can be used for upper and lower distribution in normal use, with both the first body and the second body being above. The present invention in a use, the normal state of time, the first body in the second body above, the two separate use, the second body can be separated from the support arm for separate use, at the same time, the first body and/or the second body relative to the wall can be adjusted for angle, and used to change the angle of the water outlet, preferably can be used in a spherical connection, specifically can be as follows the first joint and the second joint is spherical joints, when a combination is required, i.e. the new water outlet mode can have the following pattern: 1, the two water outlet panel merger combined to form a larger water outlet panel, so that has a larger water outlet area for showering, that is, after the combination, the water outlet area is not less than the sum of the first panel and the second panel of the water outlet area; 2, another aspect is the first panel and the second panel lateral separation distribution, forming a horizontal shower combination, while the first panel and the second panel can change the water angle, so that the user has a higher shower experience, such as the first panel and the second panel directly hit the user's two shoulders, and the head will not be washed by water, providing a soothing effect on the shoulders, which cannot be achieved by existing single top spray.

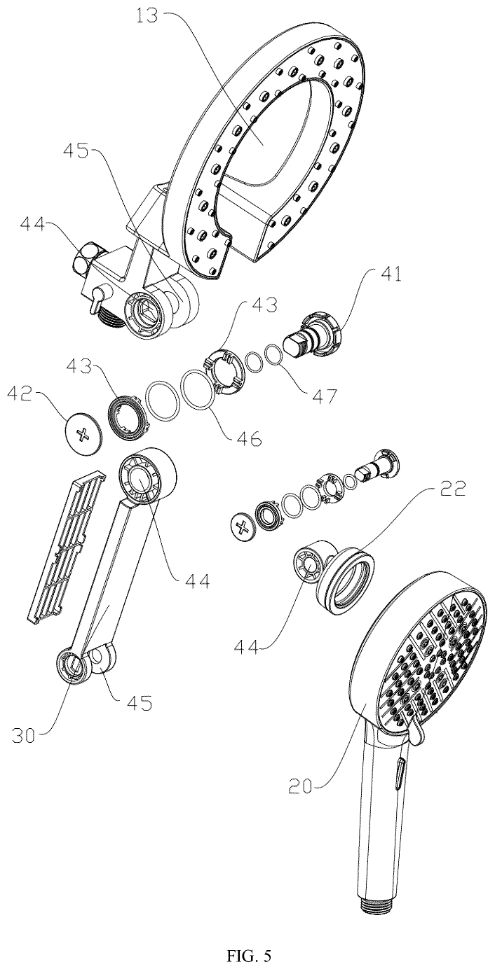

Further, the rotationally connecting damping mechanism comprises a bolt 41 and a nut 42, which are matched with each other, the bolt and nut rotationally connecting the support arm to the first body and the second joint, an outer circumference of the bolt is equipped with a friction ring 43, and one end face of the friction ring is matingly connected to the support arm, and other end face of the friction ring is cooperatively connected to the first body or the second joint. Referring to FIG. 5 of the specification, the two ends of the support arm, the first body and the second joint are provided with connection holes 44, the connection hole at one end of the support arm are docked with the connection holes on the first body, and the connection hole at the other end of the support arm are docked with the connection hole on the second joint, which these connection holes are used to threading the bolts, and there are matching surfaces 45 around the periphery of the connection hole, which are provided with the friction ring to tightly fit the connection, and the matching surfaces can be provided on the support arm, the first body, or the second joint. Preferably, a first wear-resistant ring 46 is also provided on one of the end faces of the friction ring, and the first wear-resistant ring can be closely fitted with the matching surface to provide a better damping effect, and similarly, a second wear-resistant ring 47 is also provided around the periphery of the bolt, and the second wear-resistant ring is provided in the inner periphery of the bolt and the connection hole, which also strengthens the damping effect and ensures that the water outlet angle of the first panel and the second panel remains unchanged without any external force, and it has a very good stability.

Further, the first panel can change the water outlet angle by rotating the first body under the cooperation of the first joint, and the second panel can change the water outlet angle by rotating the second body under the cooperation of the second joint. Preferably, the first joint and the second joint can be a ball hinged joint, so that the first panel and the second panel can be a universal spherical connection, so that the water outlet direction of the first panel and the second panel can be changed, which the overall water outlet device has a better combination of water outlet effect, increasing the user's shower experience, and not making the product too single.

In embodiment I of the present invention, one end of the support arm is rotationally connected to the first body, and the other end of the support arm is capable of being flipped forward or backward with respect to the first body, at which time the rotation axes of the two ends of the support arm are rotated along the lateral. Referring to the accompanying drawings of the specification, the support arm has two rotation points located at each end of the support arm, and the rotation point located above drives the second body towards the first body. After the support arm has been flipped, the first panel is capable of being added to the second panel to form an outlet panel 100 with an increased water outlet area, increasing the water outlet area, that is, these two are combined to form a panel with a large water outlet area. In order to make the use more integral, the rotation point of the support arm located at the bottom (which is located at the top after the rotation, which is close to the second body) can be used to adjust the water outlet angle of the second panel, so that the water outlet angle of the second panel is the same as that of the first panel, so that the water outlet angle of the integrated water outlet panel 100 as a whole is the same, or of course it cannot be the same to form an alternative way of water outlet.

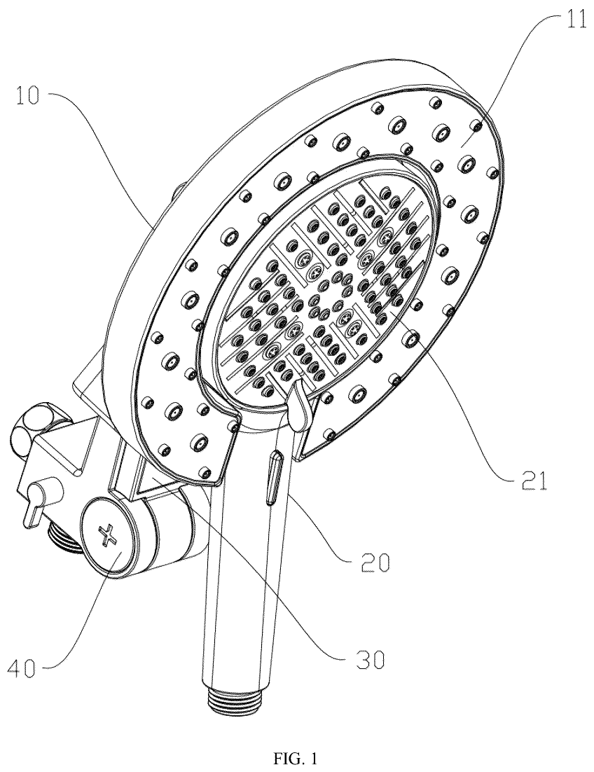

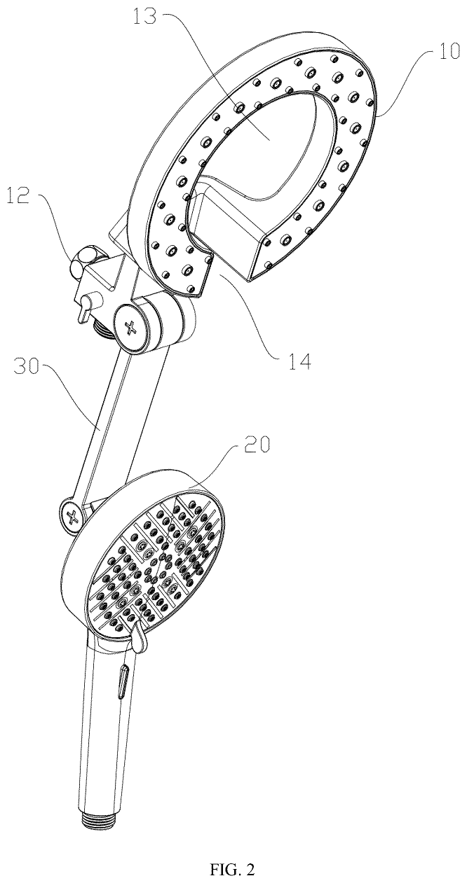

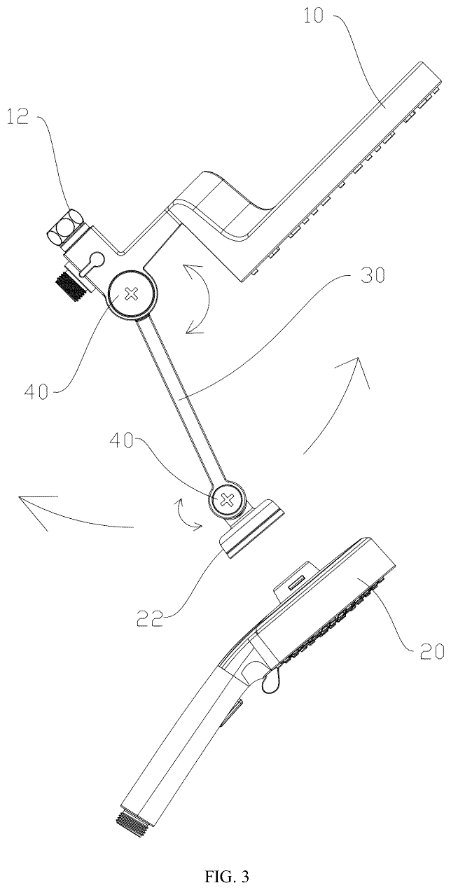

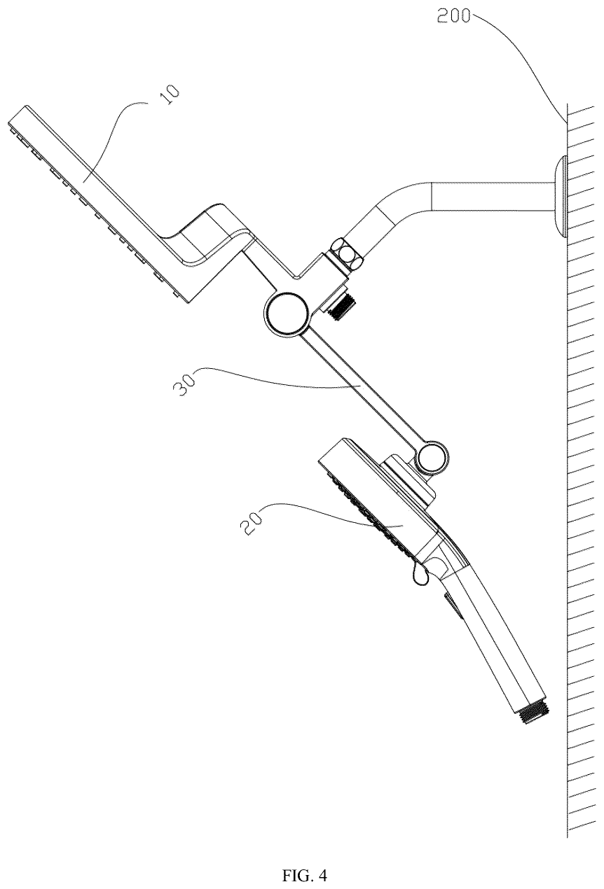

With specific reference to FIGS. 1-5 of the accompanying drawings of the specification, in a first embodiment of embodiment I of the present invention, the first panel is provided with a vacant portion 13, which can be a side on the left and right lateral sides or a lower lateral side, the second panel can be placed within the vacant portion, and the contour of the second panel can be adapted to the contour of the vacant portion, and preferably, there is a give way slot 14 provided on the first body, which can be used to fit with the support arm, so that when the first panel is combined with the second panel, the support arm is located inside the give way slot, so that the appearance of the integrated water outlet panel has a good coordination.

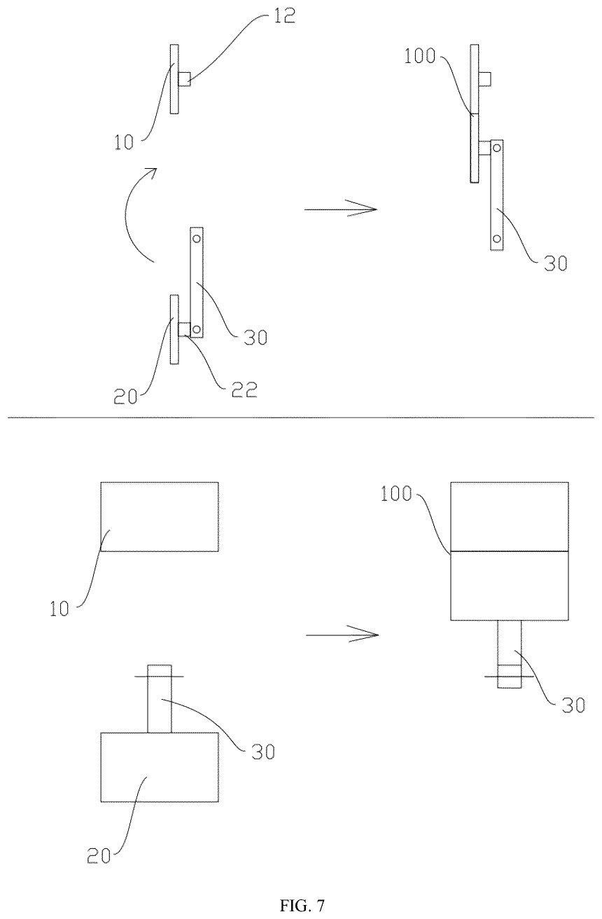

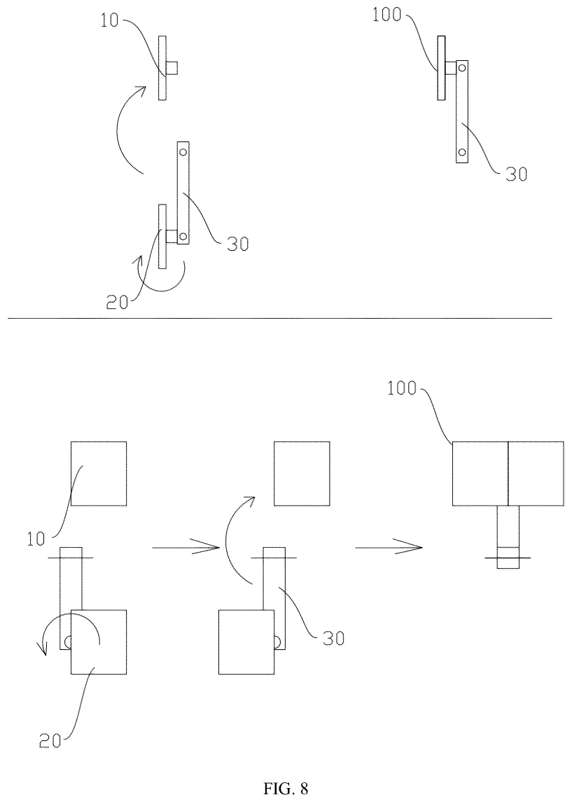

In a second embodiment of embodiment I of the present invention, the first panel is a polygonal panel, the second panel is a polygonal panel, the second panel can be located in and close to an outer peripheral side of the first panel after being flipped with the rotational cooperation of the support arm, which the outer peripheral side can be a left and right lateral side or an upper and lower lateral side, so as to enable the first panel and the second panel to form a new polygonal panel. The following is an example in which both the first panel and the second panel are quadrilateral, with specific reference to FIG. 7 of the accompanying drawings of the specification, which shows that the second panel can be located below or above after it is flipped in conjunction with the rotation of the support arm, and can be directly combined to form a larger water outlet panel 100. Similarly, with specific reference to FIG. 8 of the accompanying drawings of the specification, in this embodiment, the first panel and the second panel can be rotated relative to each other, and in the first state, the second panel is located below the first panel and is in a vertically relative flush state, and when it is necessary to combine the two panels, the second panel rotates relative to the support arm by 180°, so that the second panel is located underneath the outer periphery side of the first panel, and then the support arm is flipped to place the second panel on the peripheral side of the first panel, so that the two are in a state of horizontal relative alignment.

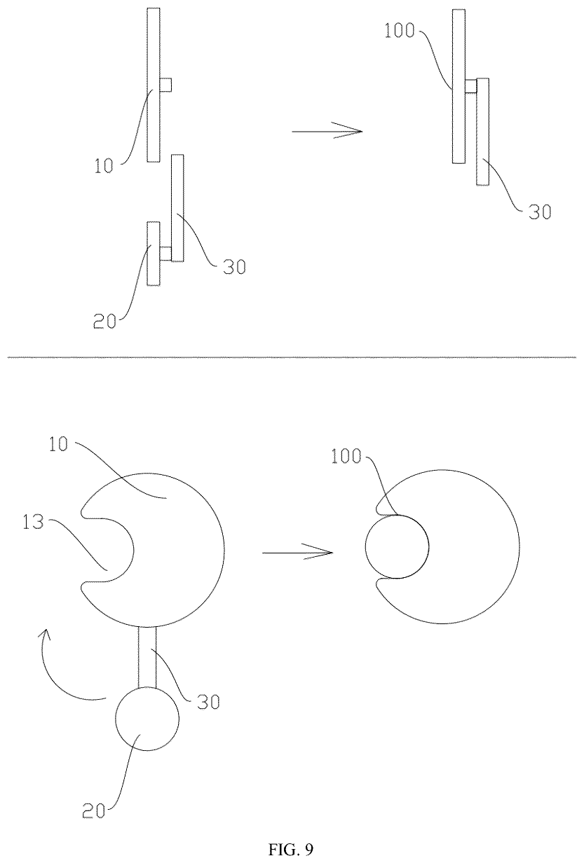

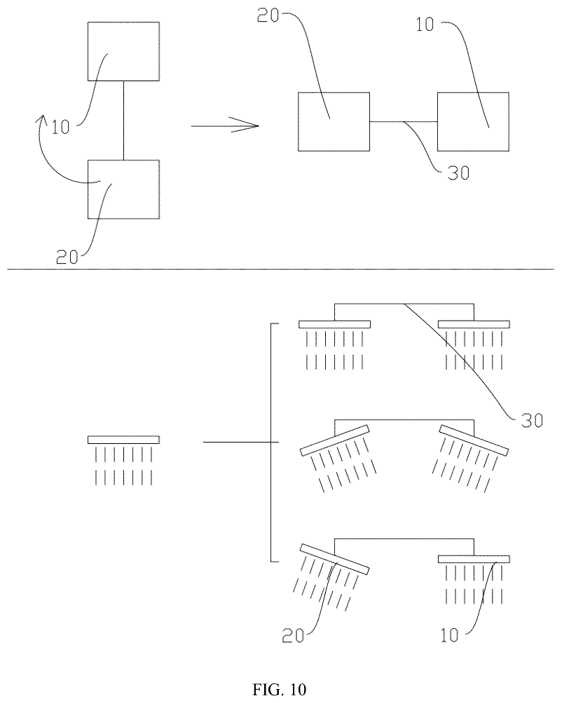

With reference to FIGS. 9-10 of the accompanying drawings of the specification, in the embodiment II of the present invention, one end of the support arm is rotationally connected to the first body, and the other end of the support arm is capable of being flipped peripherally next to the first body, where the axis of rotation of both ends of the support arm is in the longitudinal direction; after the support arm is flipped, the second panel is capable of being located next to the periphery of the first panel to form a new water outlet pattern, or the first panel is added to the second panel to form a larger water outlet panel. In the present embodiment, the support arm is rotated relative to parallel to the wall, so that the second panel is moved relative to the first panel, so that the second panel can be combined with the first panel to form a larger water outlet panel 100, or these two are arranged horizontally to form a new combination of the water outlet mode, the existing combination of the water outlet is basically arranged in a vertical direction, which it is not possible to form a coverage in the width direction, and the present embodiment can achieve a coverage in the width direction, and a large-sized water outlet in the width direction can be realized in the case of a small-sized water outlet panel.

With reference to FIG. 9 of the accompanying drawings of the specification, in the first embodiment of embodiment I of the present invention, the first panel is provided with a vacancy portion 13, wherein when the second panel is rotated with the support arm, the second panel can be placed within the vacancy portion, and the contour of the second panel can be adapted to the contour of the vacancy portion.

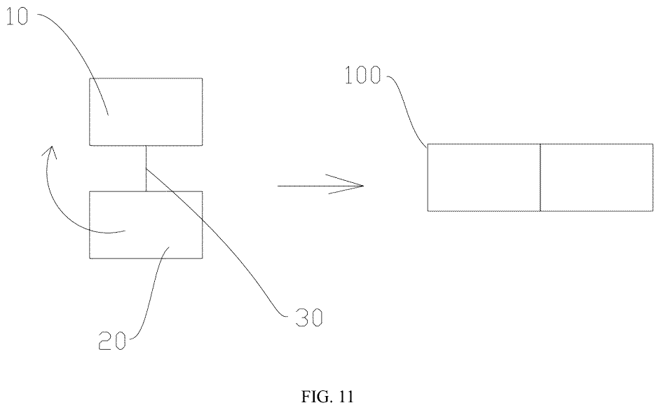

In the second embodiment of embodiment II of the present invention, the first panel is a polygonal panel and the second panel is a polygonal panel, the second panel being able to be located on and close to the side of the first panel after being flipped with the rotational cooperation of the support arm, which the outer peripheral side can be a left and right lateral side or an upper and lower lateral side, so as to enable the first panel and the second panel to form a new polygonal panel. The following is an example in which both the first panel and the second panel are quadrilateral, with specific reference to FIG. 10 of the accompanying drawings of the specification, when the support arm is turned so that the support arm is level with the ground, so that the first panel and the second panel are in lateral distribution, thus forming a new water outlet pattern. Between the first panel and the second panel there is a vacant place, and during the specific shower, the head position can be located under the vacant place, which allows the two panels to discharge water and flush people's shoulders or extended arms (the water flow is not suitable for hitting the head), forming a massage effect. At the same time, it can also change the direction of the first and/or second panel's discharge, allowing people to have a better experience. Similarly, the first panel can be directed towards the head for water discharge, and the second panel can be directed towards the arms or other areas for spraying, allowing a water outlet device to have multiple angles and directions for water discharge, which greatly improves the user's shower experience. Of course, the first panel and the second panel can also be overlapped, and with reference to FIG. 11 of the accompanying drawings of the specification, in essentially the same manner as embodiment I, in one use, the second panel is capable of being rotated relative to the second joint, which is used to adapt tubing that is connected to the second body.

In the present invention, the second joint and the second panel may also be connected by a magnetic rear snap, which allows the second panel to rotate around the second connector, which is prior art and will not be elaborated in detail.

The foregoing description illustrates and describes the preferred embodiments of the present invention, and as previously mentioned, it should be understood that the present invention is not limited to the form disclosed herein, and should not be regarded as exclusive of other embodiments, but is susceptible to a variety of other combinations, modifications, and environments and is capable of being altered by the above teachings or by skill or knowledge in the art or in related fields, within the scope of the inventive concepts described herein. And the alterations and variations made by those in the art that do not depart from the spirit and scope of the present invention shall all be within the scope of protection of the appended claims of the present invention.

What is claimed is:

1. A water outlet device, comprising:
a first body, wherein the first body comprises a first panel for water outlet;
a second body, wherein the second body comprises a second panel for water outlet;
a support arm, wherein a first end of the support arm is allowed to be rotationally and cooperatively connected with the first body, and a second end of the support arm is allowed to be rotationally and cooperatively connected with the second body; the second body is allowed for being moved relative to the first body under a rotationally coupled of the support arm, wherein the first panel and the second panel are allowed to converge or separate.

2. The water outlet device according to claim 1, wherein the first body comprises a first joint allowed for being rotationally and cooperatively connected to a wall, and the second body comprises a second joint rotationally and cooperatively connected to the second end of the support arm; a first rotationally connecting damping mechanism is provided between the first end of the support arm and the first body, and a second rotationally connecting damping mechanism is further provided between the second end of the support arm and the second joint.

3. The water outlet device according to claim 2, wherein each of the first and second rotationally connecting damping mechanisms comprises a bolt and a nut matched with each other, the bolt and nut rotationally connects the support arm to the first body and the second joint, an outer circumference of the bolt is equipped with a friction ring, and a first end face of the friction ring is matingly connected to the support arm, and a second end face of the friction ring is cooperatively connected to the first body or the second joint.

4. The water outlet device according to claim 3, wherein the first panel is allowed for changing a water outlet angle by rotation in conjunction with the first joint, and the second panel is allowed for changing the water outlet angle by rotation in conjunction with the second joint.

5. The water outlet device according to claim 1, wherein the first end of the support arm is rotationally connected to the first body, and the second end of the support arm is allowed for being flipped forward or backward with respect to the first body; after the support arm has been flipped, the first panel is allowed for being added to the second panel to form an outlet panel with an increased water outlet area.

6. The water outlet device according to claim 5, wherein the first panel is provided with a vacant portion, the second panel is allowed to be placed within the vacant portion, and a contour of the second panel is allowed to be adapted to a contour of the vacant portion.

7. The water outlet device according to claim 5, wherein each of the first panel and the second panel is a polygonal panel, the second panel is allowed to be located on and adjacent to a side of the first panel after being flipped with a rotational cooperation of the support arm, wherein the first panel and the second panel form a new polygonal panel.

8. The water outlet device according to claim 1, wherein the first end of the support arm is rotationally connected to the first body, and the second end of the support arm is allowed for being flipped sideways with respect to the first body; after the support arm is flipped, the second panel is allowed to be disposed on a side of the first panel, or the first panel and the second panel are allowed to be added together to form an outlet panel with an increased area for the water outlet.

9. The water outlet device according to claim 8, wherein the first panel is provided with a vacant portion, the second panel is allowed to be placed within the vacant portion, and a contour of the second panel is allowed to be adapted to a contour of the vacant portion.

10. The water outlet device according to claim 8, wherein each of the first panel and the second panel is a polygonal panel, the second panel is allowed to be located on and adjacent to the side of the first panel after being flipped with a rotational cooperation of the support arm, wherein the first panel and the second panel form a new polygonal panel.

11. The water outlet device according to claim 2, wherein the first end of the support arm is rotationally connected to the first body, and the second end of the support arm is allowed for being flipped forward or backward with respect to the first body; after the support arm has been flipped, the first panel is allowed for being added to the second panel to form an outlet panel with an increased water outlet area.

12. The water outlet device according to claim 3, wherein the first end of the support arm is rotationally connected to the first body, and the second end of the support arm is allowed for being flipped forward or backward with respect to the first body; after the support arm has been flipped, the first panel is allowed for being added to the second panel to form an outlet panel with an increased water outlet area.

13. The water outlet device according to claim 4, wherein the first end of the support arm is rotationally connected to the first body, and the second end of the support arm is allowed for being flipped forward or backward with respect to the first body; after the support arm has been flipped, the first panel is allowed for being added to the second panel to form an outlet panel with an increased water outlet area.

14. The water outlet device according to claim 2, wherein the first end of the support arm is rotationally connected to the first body, and the second end of the support arm is allowed for being flipped sideways with respect to the first body; after the support arm is flipped, the second panel is allowed to be disposed on a side of the first panel, or the first panel and the second panel are allowed to be added together to form an outlet panel with an increased area for the water outlet.

15. The water outlet device according to claim 3, wherein the first end of the support arm is rotationally connected to the first body, and the second end of the support arm is allowed for being flipped sideways with respect to the first body; after the support arm is flipped, the second panel is allowed to be disposed on a side of the first panel, or the first panel and the second panel are allowed to be added together to form an outlet panel with an increased area for the water outlet.

16. The water outlet device according to claim 4, wherein the first end of the support arm is rotationally connected to the first body, and the second end of the support arm is allowed for being flipped sideways with respect to the first body; after the support arm is flipped, the second panel is allowed to be disposed on a side of the first panel, or the first panel and the second panel are allowed to be added together to form an outlet panel with an increased area for the water outlet.
